(19) United States
(12) Patent Application Publication
(10) Pub. No.: US 2015/0079158 A1
(43) Pub. Date: Mar. 19, 2015

(54) METHOD TO STABILIZE LIPOSOME EMULSIONS FOR BIOCIDAL DELIVERY

(71) Applicants: Yongtao Shi, Shanghai (CN); Juan Jiang, Shanghai (CN); Qiaoni Liu, Shanghai (CN); Linna Wang, Shanghai (CN); Yan Yang, Shanghai (CN)

(72) Inventors: Yongtao Shi, Shanghai (CN); Juan Jiang, Shanghai (CN); Qiaoni Liu, Shanghai (CN); Linna Wang, Shanghai (CN); Yan Yang, Shanghai (CN)

(73) Assignee: General Electric Company, Schenectady, NY (US)

(21) Appl. No.: 14/395,068

(22) PCT Filed: Apr. 19, 2012
(86) PCT No.: PCT/CN2012/074344

§ 371 Date: Oct. 17, 2014

(51) Int. Cl. C02F 1/50; A01N 25/04; A01N 25/22; A01N 43/80; A01N 33/20

(52) U.S. Cl. CPC C02F 1/50; A01N 43/80; A01N 33/20; A01N 25/22; A01N 25/04; C02F 2303/04
USPC 424/450; 514/372

(57) ABSTRACT

An improved stabilized biocidal delivery system has been found which increases the efficiency and effectiveness of introducing antimicrobial compounds into complex bio-film matrices through the use of liposome emulsion in an ethoxylated compound, thereby removing the bio-fouling in industrial water bearing systems, including piping, heat exchangers, condensers, filtration systems and fluid storage tanks. The liposome emulsion is comprised of a vesicle encapsulated biocide that is stabilized against chemical and heat degradation over longer periods of time than previously possible through the incorporation of one or more stabilizer compounds.

### FIELD OF INVENTION

The field of the invention generally relates to biocidal delivery systems for providing products or compounds, such as chemicals, to industrial systems. The invention also relates to compositions for use in said systems.

### BACKGROUND OF THE INVENTION

Bacterial bio-films exist in natural, medical, and industrial environments. The bio-films offer a selective advantage to microorganisms to ensure the microorganisms' survival or to allow them a certain time to exist in a dormant state until suitable growth conditions arise. Unfortunately, this selective advantage poses serious threats to health, or to the efficiency and lifetime of industrial systems. The bio-films must be minimized or destroyed to improve the efficiency of industrial systems, or remove the potential health threats.

Many industrial or commercial operations rely on large quantities of water for various reasons, such as for cooling systems, or said systems may produce large quantities of wastewater, which result in the creation of bio-films that need to be treated. These industries include, but are not limited to, agriculture, petroleum, oil drilling, oil pipelines, oil storage, gas drilling, gas pipelines, gas storage, chemical, pharmaceutical, mining, metal plating, textile, papermaking, brewing, food and beverage processing, and semiconductor industries. In these operations, naturally occurring bio-films are continuously produced and often accumulate on numerous structural or equipment surfaces or on natural or biological surfaces. In industrial settings, the presence of these bio-films causes a decrease in the efficiency of industrial machinery, requires increased maintenance and presents potential health hazards. An example is the surfaces of water cooling towers which become increasingly coated with bio-film slimes produced by a wide variety of microorganisms which constrict water flow and reduce heat exchange capacity. Specifically, in flowing or stagnant water, bio-films can cause serious problems, including pipeline blockages and the corrosion of equipment by the growth of micro-organisms and microbes that thrive beneath the bio-film as well as the growth of potentially harmful pathogenic bacteria. Water cooling tower bio-films may form a harbor or reservoir that perpetuates growth of pathogenic microorganisms such as Legionella pneumophila.

Other examples of industrial systems are those systems that are found in the food and beverage industries. Food preparation lines are routinely plagued by bio-film build-up both on the machinery and on the food product where bio-films often include potential pathogens. Industrial bio-films, such as those found in the food industry, are complex assemblages of insoluble polysaccharide-rich biopolymers, which are produced and elaborated by surface dwelling microorganisms. More particularly, bio-films or microbial slimes are composed of polysaccharides, proteins and lipopolysaccharides extruded from certain microbes that allow them to adhere to solid surfaces in contact with water environments and form persistent colonies of sessile bacteria that thrive within a protective film. The film may allow anaerobic species to grow, producing acidic or corrosive conditions. To control these problems, processes and antimicrobial products are needed to control the formation and growth of bio-films. Control of bio-films involves the prevention of microbial attachment and/or the removal of existing bio-films from surfaces. While removal in many contexts is accomplished by short cleansing treatments with highly caustic or oxidizing agents, the most commonly used materials to control bio-films are biocides and dispersants.

In U.S. Pat. No. 5,411,666 to Hollis et al., a method of removing a bio-film or preventing buildup of a bio-film on a solid substrate is taught, comprising a combination of at least two biologically produced enzymes, such as an acidic or alkaline protease and a glucoamylase or alpha amylase and at least one surfactant. U.S. Pat. No. 6,759,040 to Manyak et al. teaches a method for preparing bio-film degrading, multiple specificity, hydrolytic enzyme mixtures that are targeted to remove specific bio-films while U.S. Pat. No. 5,512,213 to Paterson et al. teaches a method for stabilizing an aqueous solution containing an isothiazolin compound against chemical decomposition through the incorporation of a stabilizing amount of a metal salt. The cation of said metal salt is an alkali metal while the anion is selected from the group consisting of acetate, citrate, phosphate and borate.

Finally, U.S. Pat. No. 6,267,897 to Robertson et al. relates to a method of inhibiting bio-film formation in commercial and industrial water systems by adding one or more plant oils to the system. However, although the biocides are effective in controlling dispersed microorganism suspensions, i.e., planktonic microbes, biocides do not work well against sessile microbes, the basis of bio-films. This is due to the fact that biocides have difficulty penetrating the polysaccharide/protein slime layers surrounding the microbial cells. Thicker bio-films see little penetration of biocides and poor biocide efficacy is the result. One known method of trying to better control bio-films has been the addition of dispersants and wetting agents to biocide compositions to enhance biocide efficacy. Bio-dispersants may operate to keep planktonic microbes sufficiently dispersed so that they do not agglomerate or achieve the local densities necessary to initiate the extracellular processes responsible for anchoring to a surface, or initiating film- or colony-forming mechanisms. As components in biocidal treatment formulations, these bio-dispersants have helped in opening channels in the bio-film to allow better permeability of the toxic agents and to better disperse the microbial aggregates and clumps that have been weakened and released from the surfaces. However, bio-dispersants have proven to be more effective in preventing initial bio-film formation than in removing existing bio-films. In many cases, the activity of bio-dispersants has been responsible for only 25 to 30% biomass removal from bio-fouled surfaces, even when used in conjunction with a biocidal agent.

Therefore, a clear need still exists for an efficient and effective means for delivering antimicrobial compounds that are better able to penetrate existing bio-films and bio-film matrices, and more effective in killing microorganisms contained within a bio-film matrix, thus killing and eliminating bio-film, as well as future formation nor buildup of bio-film, in systems, such as industrial systems. Decreasing the fouling of microfiltration systems, and providing less frequent cleaning and/or replacement which would enhance the overall filtration process, are also needs which should be addressed.

### BRIEF DESCRIPTION OF THE INVENTION

A biocidal delivery composition and method of use are disclosed. The biocidal delivery composition is a liposome emulsion, in which some lipid particles are dispersed in water. The lipid matrix may be sensitive to pH, redox potential, salts concentration, or other changes. Acidic anti-microbial compounds, such as isothiazolins (pH 1˜3), cause liposome degradation and eventually physical separation. Poor dispersion of lipid particles also causes irreversible phase separation of liposome emulsions. At elevated temperatures, especially 35-50° C., these degradation and phase separation processes accelerate, resulting in unsatisfactory product not suitable for commercial use. The storage stability of the liposome biocidal delivery composition is critical for its commercial application.

It was surprising discovered that the storage stability or “shelf life” of liposome emulsions may be increase through the addition of a stabilizer. Suitable stabilizers for liposome emulsions are polymers containing ethylene oxide groups. A buffer composition may also be added to improve the storage stability of the liposome emulsion.

One embodiment discloses a biocidal delivery composition for delivering an anti-microbial composition into biofouling or a bio-film of the type containing at least one micro-organism species and present in an industrial system, wherein the biocidal delivery composition comprises at least one stabilizer and a vesicular structure encapsulating an anti-microbial composition therein.

The stabilizer may comprise a polymer containing at least one ethylene oxide monomeric unit. In another embedment, the stabilizer comprises at least one ethoxylated compound. The ethoxylated compound may have the structure set forth in Formula I:

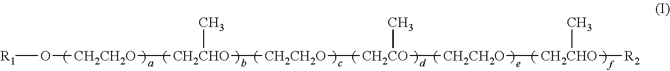

where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50; the sum of a, c and e is an integer from 5 to 200; the sum of b, d, and f is a number from 0 to 50.

Suitable ethoxylated compounds include, but are not limited to, alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, poly(ethylene glycol-co-propylene glycol) monoalkyl ether.

In another embodiment, the stabilizer may have a hydrophilic-lipophilic balance value ranging from about 8 to about 20.

In another embodiment, a biocidal delivery composition is disclosed wherein the stabilizer is incorporated in an amount ranging from about 0.1 wt % to about 10 wt % of the total biocide delivery composition. Alternatively, the stabilizer may be incorporated in an amount ranging from about 0.5 wt % to about 5 wt % of the total biocide delivery composition.

In another embodiment, the vesicular structure of the boicidal delivery composition comprises a liposome structure with at least one lipid. Suitabile lipids include, but are not limited to, phospholipid, lecithin, phosphatidyl choline, glycolipid, triglyceride, sterol, fatty acid, and sphingolipid. In another embodiment, the biocidal delivery composition comprises from about 1.0 wt % to about 20.0 wt % of the lipid therein. Alternatively, the biocidal delivery composition comprises from about 5.0 wt % to about 10.0 wt % of the lipid therein.

In another embodiment, the biocidal delivery composition comprises an anti-microbial composition with at least one non-oxidizing biocide. Suitable non-oxidizing biocides include, but are not limited to, 5-chloro-2-methyl-4-isothiazolin-3-one, 2-methyl-4-isothiazolin-3-one, guanidine or biguanidine salts, quaternary ammonium salts, phosphonium salts, 2-bromo-2-nitropropane-1,3-diol (BNPD), n-alkyl-dimethylbenzylammonium chloride, dodecylguanidine hydrochloride, glutaraldehyde, and combinations thereof. In another embodiment, the biocidal delivery composition comprises from about 0.1 wt % to about 90.0 wt % of at least one non-oxidizing biocide therein. Alternatively, the biocidal delivery composition comprises from about 1.5 wt % to about 30.0 wt % of the non-oxidizing biocide therein.

In another embodiment, the biocidal delivery composition further comprises a stabilizing pH buffer. Suitable stabilizing pH buffers include, but are not limited to, citrate salts, acetate salts, and chlorate salts. The biocidal delivery composition may comprise from about 0.02 wt % to about 20 wt % stabilizing buffer therein.

In another embodiment, the biocidal delivery composition is used in an industrial system that is an aqueous system. In another embodiment, the industrial system may be water distribution systems, cooling towers, boiler systems, showers, aquaria, sprinklers, spas, cleaning bath systems, air washers, pasteurizers, air conditioners, fluid transporting pipelines, storage tanks, ion exchange resins, food and beverage processing lines, paint spray booths, metalworking fluid baths, coal and mineral slurries, metal leaching fluids, wastewater treatment facilities, pulping and papermaking suspensions, mollusk control, acid mine drainage, oil drilling pipes, oil pipelines, oil storage tanks, gas drilling pipes, gas pipelines, or any industrial application prone to microbial induced bio-film formation or microbial induced corrosion.

Another embodiment discloses a method for delivering a biocidal composition into an industrial system with biofouling or a bio-film. The method comprises: forming liposomes with a vesicular structure which encapsulates at least one anti-microbial composition; combining the liposomes with at least one stabilizer; and introducing an effective amount of the biocidal composition to the industrial system.

In another embodiment, the liposome structures are introduced at from about 0.01 ppm to about 200 ppm by volume of the industrial system. In another embodiment, the liposome structures are introduced at from about 0.05 ppm to about 50 ppm by volume of the industrial system. Alternatively, the liposome structures may be introduced at from about 0.05 ppm to about 5 ppm by volume of the industrial system.

In another embodiment, the stabilizer may comprise a polymer containing at least one ethylene oxide monomeric unit. In another embodiment, a method is disclosed wherein the stabilizer used comprises at least one ethoxylated compound. The ethoxylated compound may have the structure set forth in Formula I:

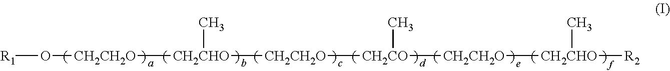

where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50; the sum of a, c and e is an integer from 5 to 200; the sum of b, d, and f is a number from 0 to 50.

Suitable ethoxylated compounds include, but are not limited to, alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, poly(ethylene glycol-co-propylene glycol) monoalkyl ether.

Another embodiment discloses a method wherein the stabilizer is incorporated in an amount ranging from about 0.1 wt % to about 10 wt % of the total biocide delivery composition. Alternatively, the stabilizer is incorporated in an amount ranging from about 0.5 wt % to about 5 wt % of the total biocide delivery composition.

### DETAILED DESCRIPTION OF THE INVENTION

Bacterial bio-films threaten the efficiency and lifetime of industrial systems, such as for cooling systems. The bacterial bio-films must be minimized, destroyed or removed.

The compositions and methods disclose biocide delivery compositions comprising liposome vesicular carriers. The biocides and liposome vesicular carriers used are of the type disclosed in U.S. Pat. No. 7,824,557, U.S. 2010/0239630 A1 and U.S. 2011/0177147 A1, proprietary owned by GE WPT. The above patent and publications are incorporated by reference herein. The biocidal delivery compositions are liposome emulsions, in which some lipid particles are dispersed in water. The lipid matrix is sensitive to pH, redox potential, salts concentration, or other changes. Acidic anti-microbial compounds, such as isothiazolins (pH 1˜3), cause liposome degradation and eventually physical separation. Poor dispersion of lipid particles also causes irreversible phase separation of liposome emulsions. At elevated temperature, especially 35-50° C., these degradation and phase separation processes accelerate resulting in unsatisfactory product not suitable for commercial use. The storage stability of liposome biocidal delivery system is critical for its commercial application.

It was surprisingly discovered that the storage stability or “shelf life” of liposome emulsions may be increased through the addition of a stabilizer. Suitable stabilizers for liposome emulsions are ethoxylated compounds. A buffer composition may also be added to improve the storage stability of the liposome emulsion.

One embodiment discloses a biocidal delivery composition for delivering an anti-microbial composition into biofouling or a bio-film of the type containing at least one micro-organism species and present in an industrial system, wherein the biocidal delivery composition comprises at least one stabilizer and a vesicular structure encapsulating an anti-microbial composition therein.

In another embodiment, a biocidal delivery composition is disclosed wherein the stabilizer used comprises at least one ethoxylated compound. The ethoxylated compound may have the structure set forth in Formula I:

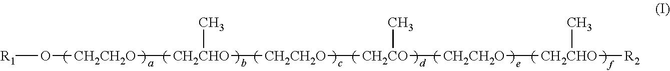

where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50; the sum of a, c and e is an integer from 5 to 200; the sum of b, d, and f is a number from 0 to 50.

Suitable ethoxylated compounds include, but are not limited to, alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, poly(ethylene glycol-co-propylene glycol) monoalkyl ether. The moles of ethylene oxide, designated (a, c, or e in Formula I), in the ethoxylated compound may repeat. This number is often referred to as the EO number or EO mol %. The larger the EO portion of the ethoxylated compound, the more water soluble the compound is. Another indicator of water solubility is the hydrophilic-lipophilic balance value. Generally materials with a hydrophilic-lipophilic balance value greater than 10 are water soluble. It was also surprisingly discovered that ethoxylated compounds that are water soluble are effective stabilizers. In another embodiment, the stabilizer may have a hydrophilic-lipophilic balance value from about 8 to about 20.

In another embodiment, a biocidal delivery composition is disclosed wherein the stabilizer is incorporated in an amount ranging from about 0.1 wt % to about 10 wt % of the total biocide delivery composition. Alternatively, the stabilizer may be incorporated in an amount ranging from about 0.5 wt % to about 5 wt % of the total biocide delivery composition.

Liposomes, or lipid bodies, are systems in which lipids are added to an aqueous buffer to form vesicles, structures that enclose a volume. The liposomes may be comprised of lipids selected from the group consisting of phospholipids, lecithin, phosphatidyl choline, glycolipid, triglyceride, sterol, fatty acid, sphingolipid, or combinations thereof. More specifically, liposomes are microscopic vesicles, most commonly composed of phospholipids and water. The liposomes may be made from phospholipids derived from various sources, including, but not limited to soybeans and eggs. When properly mixed, the phospholipids arrange themselves into a bi-layer or multi-layers, very similar to a cell membrane, surrounding an aqueous volume core.

Liposomes may be produced to carry various compounds or chemicals within the aqueous core, or the desired compounds can be formulated in a suitable carrier to enter the lipid layer(s). The liposomes may be manufactured by several known processes. Such processes include, but are not limited to, controlled evaporation, extrusion, injection, micro-fluid processors and rotor-stator mixers. Liposomes may be produced in various sizes and may be manufactured in submicron to multiple micron diameters, typically from about 10 nanometers to greater than about 200 micrometers. When produced in sizes from about 100 nanometers to about 20 micrometer sizes the liposomes are very similar in size and composition to most microbial cells. The biocide or antimicrobial compound containing-liposomes should be produced in sizes that mimic bacterial cells, for example, from about 0.05 to about 15μ, or alternately, about 0.1 to 10.0μ. Details pertaining to liposome production processes may be gleaned, for example, in U.S. Pat. Nos. 5,807,572 and 7,491,409. Both of these patents are incorporated by reference herein. The liposome formulations are usually mixtures of particles of various sizes, up to 200 microns, preferably range from about 100 nanometers to about 10 microns in diameter.

In another embodiment, the lipid in the liposome emulsion is present in an amount of from about 1.0 wt % to about 20.0 wt %. Alternatively, the lipid is present in an amount of from about 5.0 wt % to about 10.0 wt %.

While the terms “antimicrobial” or “biocide” or “biocidal” have been employed to describe the agent carried by the liposome, these agents need not be the highly bioactive materials normally understood by those terms, but may include a number of relatively harmless materials that become highly effective simply by virtue of their highly localized release. Thus, for example, surfactants or harmless ammonium or phosphonium halide salts, when release locally, may affect the normal action of extracelluar colony-forming secretions, and are to be included as antimicrobial or biocidal agents for purposes of the invention, and the same mechanism may be employed to deliver other treatment chemicals to the targeted bio-film sites.

Various types of antimicrobial compositions can be incorporated into the liposome and are effective to kill or destroy the desired microbial organism. The antimicrobial composition may be a biocide, enzyme, bacteriophage, etc. The biocide may be a non-oxidizing or oxidizing compound, or combinations thereof.

In another embodiment, the biocidal delivery composition comprises an anti-microbial composition with at least one non-oxidizing biocide. Suitable non-oxidizing biocides 5-chloro-2-methyl-4-isothiazolin-3-one, 2-methyl-4-isothiazolin-3-one, guanidine or biguanidine salts, quaternary ammonium salts, phosphonium salts, 2-bromo-2-nitropropane-1,3-diol (BNPD), n-alkyl-dimethylbenzylammonium chloride, dodecylguanidine hydrochloride, and glutaraldehyde. In another embodiment, the biocidal delivery composition comprises from about 0.1 wt % to about 90.0 wt % of at least one non-oxidizing biocide therein. Alternatively, the biocidal delivery composition comprises from about 1.5 wt % to about 30.0 wt % of said non-oxidizing biocide therein.

In another embodiment, the biocidal delivery composition further comprises a stabilizing pH buffer. Suitable stabilizing pH buffers include, but are not limited to, citrate salts, acetate salts, chlorate salts, or combinations thereof. The biocidal delivery composition may comprise from about 0.02 wt % to about 20 wt % stabilizing buffer therein. Alternatively, the stabilizing pH buffer may comprise from about 2.0 wt % to about 10.0 wt %.

In another embodiment, the buffer compound may also be comprised of a mixture of two or more compounds selected from the group consisting of the metal salt of a citrate/chlorate buffer, a metal salt of an acetate/chlorate buffer, or a citrate/acetate buffer. In another embodiment, the buffer composition is comprised of a sodium citrate buffer, a sodium acetate buffer, a sodium chlorate buffer, or a sodium citrate/sodium chlorate buffer mixture.

In another embodiment, the biocidal delivery composition is used in an industrial system that is an aqueous system. In another embodiment, the industrial system may be water distribution systems, cooling towers, boiler systems, showers, aquaria, sprinklers, spas, cleaning bath systems, air washers, pasteurizers, air conditioners, fluid transporting pipelines, storage tanks, ion exchange resins, food and beverage processing lines, paint spray booths, metalworking fluid baths, coal and mineral slurries, metal leaching fluids, wastewater treatment facilities, pulping and papermaking suspensions, mollusk control, acid mine drainage, oil drilling pipes, oil pipelines, oil storage tanks, gas drilling pipes, gas pipelines, or any industrial application prone to microbial induced bio-film formation or microbial induced corrosion.

Another embodiment discloses a method for delivering a biocidal composition into an industrial system with biofouling or a bio-film. The method comprises: forming liposomes with a vesicular structure which encapsulates at least one anti-microbial composition; combining the liposomes with at least one stabilizer; and introducing an effective amount of the biocidal composition to the industrial system.

The liposomes, being similar in composition to microbial membranes, or cell walls, are readily incorporated into the existing bio-film and become entrained within the bio-film matrix. The liposomes containing biocides have improved penetration of the bio-film matrix, due to similarity in composition and structure with the bio-film. Once the liposome is incorporated or entrained within the existing bio-film matrix, the liposome will begin to disintegrate. Upon the decomposition or programmed disintegration of the liposome, the biocidal compound contained within the aqueous core of the liposome is released to react directly with the bio-film encased microorganisms, resulting in their demise. Upon the death of the organisms, the polysaccharide/protein matrix will rapidly decompose, freeing the surface from contaminating microbes. Further, the liposome structures may be introduced in the industrial system at certain targeted locations thereof. The liposome structure may comprise a biocide such as 2-bromo-2-nitropropane-1,3-diol (BNPD), and/or an isothiazolin biocide, and the isothiazolin biocide may be selected from the group consisting of 5-chloro-2-methyl-4-isothizolin-3-one, 2-methyl-4-isothiazolin-3-one, and mixtures thereof.

In yet another embodiment, effective amounts of the biocide containing liposome emulsion are introduced into industrial systems which are prone to bio-fouling and bio-film formation, or already exhibit signs of bio-fouling or bio-film formation. The effective amount will vary according to the antimicrobial compound or biocide, and the aqueous system to which it is added. One embodiment, however, provides adding the liposomes at from about 0.01 ppm to about 200 ppm by volume of the industrial system. In another embodiment, the liposome structures are introduced at from about 0.05 ppm to about 50 ppm by volume of the industrial system. Alternatively, the liposome structures are introduced at from about 0.05 ppm to about 5 ppm by volume of the industrial system.

In another embodiment, a method is disclosed wherein the stabilizer used comprises at least one ethoxylated compound. The ethoxylated compound may have the structure set forth in Formula I:

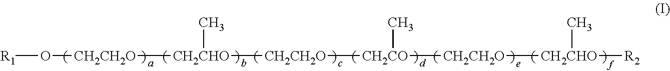

where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50.

Suitable ethoxylated compounds include, but are not limited to, alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, poly(ethylene glycol-co-propylene glycol) monoalkyl ether.

In another embodiment, the stabilizer may have a hydrophilic-lipophilic balance value ranging from about 8 to about 20.

Another embodiment discloses a method wherein the stabilizer is incorporated in an amount ranging from about 0.1 wt % to about 10 wt % of the total biocide delivery composition. Alternatively, the stabilizer is incorporated in an amount ranging from about 0.5 wt % to about 5 wt % of the total biocide delivery composition.

In yet another embodiment, a buffer stabilizer may be added to the liposome emulsion above. The buffer stabilizer may comprise a mixture of two or more compounds selected from the group consisting of a citrate salt, a chlorate salt, an acetate salt, and a metal salt. In another embodiment, the buffer composition comprises a sodium citrate buffer, a sodium acetate buffer, a sodium chlorate buffer, or a sodium citrate/sodium chlorate buffer mixture. The amount of buffer composition added to the liposome formulation is from about 0.02 wt % to about 20.0% wt % and, alternatively, in an amount of from about 2.00 wt % to about 10.0 wt %.

In the present disclosure, a delivery system has been found which increases the efficiency and effectiveness of introducing antimicrobial compounds into complex bio-film matrices through the use of liposome carriers, which can be used in natural, medical and industrial applications. In industrial applications, the delivery system can minimize or eliminate fouling in industrial systems, including, but not limited to, aqueous systems.

Aqueous systems that can be treated by this method include, but are not limited to, potable and non-potable water distribution systems, cooling towers, boiler systems, showers, aquaria, sprinklers, spas, cleaning baths, air washers, pasteurizers, air conditioners, fluid transporting pipelines, storage tanks, ion exchange resins, food and beverage processing lines, metalworking fluid baths, coal and mineral slurries, metal leaching fluids, wastewater treatment facilities, mollusk control, pulp and papermaking operations, acid mine drainage, or any application prone to bio-fouling by microbial species. Applications such as oil drilling, oil storage tanks or oil pipelines, where bio-films form in stagnant or pooled aqueous sumps or lenses along the conduit system, may also be effectively treated.

Additional applications for liposome delivery of a treatment chemical comprise natural, medical and industrial systems, such as, but not limited to anti-corrosion treatments for equipment generally, delivery of hormone, vitamin or antioxidant treatments or antibiotic and gene therapies for medical or veterinary purposes, delivery of pesticides for agriculture and commercial home uses, effective formulations of food additives and preservatives, targeted delivery for chemical and biological detection systems, color and flavor enhancement, odor control, fungicides, rodenticides, insecticides, mildew control and aquatic pest management.

The present invention will now be more specifically described and detailed in the following examples to better show one skilled in the art how to best carry out and practice the metes and bounds of the present invention. It is to be emphasized that they are for illustrative purposes only, and should not be construed as limiting the spirit and scope of the invention as recited in the claims that follow.

### EXAMPLES

A biocide-containing liposome emulsion was prepared using LECIGRAN® 6000G (150 nanometers average diameter, available from Cargill, Minneapolis, Minn.), KATHLON® 886F (available from Rohm & Haas, Philadelphia, Pa.) and PROTECTOL™ BN (available from BASF, Florham Park, N.J.) as the active ingredients. ECOSURF™ EH-40 (EO number 40, average molecular weight 2200, HLB 18.0, available from Dow, Midland, Mich.) was used for the ethoxylated compound. The charge order of these components was not restricted. The biocide-containing liposome emulsion comprised the following components in their respective percent ranges.

| Component | Percentage (wt %) |
|---|---|
| a) Water | 62.64 |
| b) Sodium citrate dihydrate | 1.34 |
| c) Citric acid monohydrate | 0.66 |
| d) KATHON ® 886F (14.0% isothiazolin) | 18.43 |
| e) PROTECTOL ™ BN (2 bromo-2-nitropropane- | 5.60 |
| 1,3 diol, BNPD) | |
| f) LECIGRAN ® 6000G (lecithin) | 10.00 |
| g) ECOSURF ™ EH-40 (75% so., ED active) | 1.33 |

Various biocide-containing liposome emulsions were made and tested under accelerated storage conditions at 35 and 50° C. If the samples showed irreversible phase separation or obvious turbidity decrease, the storage stability testes were stopped, and the storage period was recorded. The biocide-containing liposome emulsions were prepared in the following component ratios as shown in Table 1. The balance of the emulsions comprises water and is not listed.

TABLE 1

| | | | % | % | | % EO | | |
|---|---|---|---|---|---|---|---|---|
| | | % | Kathon | BNPD | % | polymer | 35° C. | 50° C. |
| Sample | Formulation | Buffer | active | active | Lecithin | active | (days) | (days) |
| Control | Sodium Acetate Buffer | 6.00 | 2.58 | 5.60 | 10.00 | 0 | 21 | 14 |
| A | Sodium Acetate Buffer | 6.00 | 2.58 | 5.60 | 10.00 | 2.00 | >90 | >30 |
| B | Sodium Acetate Buffer | 4.00 | 2.58 | 5.60 | 10.00 | 1.00 | >90 | >30 |
| C | Sodium Citrate Buffer | 4.00 | 2.58 | 5.60 | 10.00 | 2.00 | >90 | >30 |
| D | Sodium Citrate Buffer | 2.00 | 2.58 | 5.60 | 10.00 | 1.00 | >110 | >30 |
| E | Sodium Citrate Buffer | 2.00 | 2.58 | 5.60 | 7.60 | 1.00 | >90 | >30 |
| F | Sodium Citrate Buffer | 2.00 | 2.58 | 5.60 | 5.00 | 1.00 | 75 | >30 |

The degradation of the biocide-containing liposome emulsion can be qualitatively observed by the formation of an insoluble precipitate. Quantitatively, high pressure liquid chromatography (HPLC) analysis was used to determine actives concentrations for samples stored under accelerated storage conditions. The samples that passed 90 days at 35° C. or 30 days at 50° C. were taken to ambient temperature and analyzed. The stability of these liposome emulsions was determined as follows.

As shown in Table 1, ECOSURF EH-40 combined with buffer extended significantly the shelf life of liposome emulsions from 21 days to more than 110 days at 35° C., and from 14 days to more than 30 days at 50° C. HPLC analysis was executed for active degradation of 5-chloro-2-methyl-4-isothiazolin-3-one and 2-methyl-4-isothiazolin-3-one in the samples after 90 days at 35° C. or 30 days at 50° C. HPLC results showed less than 10% active degradation respectively, which indicated good chemical stability.

Additional biocide-containing liposome emulsions were made with various commercially available ethoxylated compounds and tested under accelerated storage conditions at 35 and 50° C. The ethoxylated compounds that imparted physical stability to the emulsions sufficient to meet the stability requirements of 90 days at 35° C. or 30 days at 50° C. were classified as “Good” performers and are listed in Table 2. The ethoxylated compounds that improved physical stability, but did not meet the requirements were classified as “Insufficient” performers and are also listed in Table 2. The ethoxylated compounds that did not show positive effects on the physical stability are listed in Table 3.

TABLE 2

| | | | EO Number | | | |
|---|---|---|---|---|---|---|
| Supplier | Trade name | Chemical name | (or EO %) | HLB | Mw | Performance |
| | Tween 20 | PEG(20)sorbitan monolaurate | 20 | 16.7 | 1226 | Good |
| Dow | TRITON X-405 | Octylphenol Ethoxylate (Glycols, polyethylene, | 35 | 17.6 | No data | Good |
| | | mono[(1,1,3,3-tetramethylbutyl)phenyl] ether) | | | | |
| | ECOSURF EH-9 | 2-Ethyl Hexanol EO-PO Nonionic Surfactant | 9 | 12.5 | No data | Insufficient |
| | ECOSURF EH-40 | 2-Ethyl Hexanol EO-PO Nonionic Surfactant | 40 | 18 | 2000-2300 | Good |
| Cognis | Disponil A 4065 | Mixture of ethoxylated linear fatty alcohol | 40 | 16.5 | No data | Good |
| | Disponil AFX 3070 | Modified fatty alcohol ethoxylated | 30 | 17.5 | No data | Good |
| | Disponil A 4066 | Mixture of ethoxylated linear fatty alcohol | 40 | 16.0 | No data | Good |
| | Disponil LS 500 | Ethoxylated fatty alcohol C₁₂/C₁₄ | 50 | 18.5 | No data | Good |
| Rhodia | Rhodia ABEX 2535 | Blend of ethoxylated fatty alcohols | 40 | 18 | No data | Good |
| BASF | Pluronic L35 | Methyl-oxirane polymer with oxirane | 50% | 18-23 | 1900 | Insufficient |
| | (PE3500) | | | | | |
| | Lutensol AT50 | C₁₆₋₁₈ Fatty alcohol ethoxylates | 50 | 18 | 2460 | Good |
| | powder | | | | | |
| | Lutensol AT80 | C₁₆₋₁₈ Fatty alcohol ethoxylates | 80 | 18.5 | 3780 | Good |
| | powder | | | | | |
| | Emulan To 4070 | C₁₃-Oxo alcohol ethoxylate | 40 | 18 | No data | Good |

TABLE 3

| | | | EO Number | | | |
|---|---|---|---|---|---|---|
| Supplier | Trade name | Chemical name | (or EO %) | HLB | Mw | Performance |
| Dow | TERGITOL 15-S-3 | Secondary Alcohol Ethoxylate | 3 | 8.0 | No data | Poor |
| | TERGITOL 15-S-15 | Secondary Alcohol Ethoxylate | 15 | 15.4 | No data | Poor |
| | TERGITOL 15-S-20 | Secondary Alcohol Ethoxylate | 20 | 16.3 | No data | Poor |
| | TERGITOL TMN-10 | Branched secondary alcohol | 11 | 14.4 | No data | Poor |
| | | ethoxylate (Polyoxyethylene 2,6,8- | | | | |
| | | trimethyl-4-nonyl ether) | | | | |
| | ECOSURF SA-9 | Fatty alcohol alkoxylate (seed oil | 22 | 11-13 | No data | Poor |
| | | surfactant): | | | | |
| | | 68937-66-6 (Alcohols, C₆-C₁₂, | | | | |
| | | ethoxylated, propoxylated); | | | | |
| | | 69227-22-1 (Alcohols, C₁₀₋₁₆, | | | | |
| | | ethoxylated, propoxylated). | | | | |
| | TERGITOL XH | Alkyl EO/PO polymer (High EO %, | Proprietary | — | 3740 | Poor |
| | | very low PO %; high hydrophilicity): | | | | |
| | | 9038-95-3 (Poly(ethylene glycol-co- | | | | |
| | | propylene glycol) monobutyl ether) | | | | |
| | TERGITOL XD | Alkyl EO/PO polymer (High EO %, | Proprietary | — | 2990 | Poor |
| | | low PO %; moderate hydrophilicity): | | | | |
| | | 9038-95-3 (Poly(ethylene glycol-co- | | | | |
| | | propylene glycol) monobutyl ether) | | | | |
| | TERGITOL XJ | Alkyl EO/PO polymer (low EO %, | Proprietary | — | 2510 | Poor |
| | | high PO %; low hydrophilicity): | | | | |
| | | 9038-95-3 (Poly(ethylene glycol-co- | | | | |
| | | propylene glycol) monobutyl ether) | | | | |
| BASF | Pluronic F38 | Methyl-oxirane polymer with oxirane | 80% | >24 | 4700 | Poor |
| | Pluronic F127 | Methyl-oxirane polymer with oxirane | 70% | >24 | 12600 | Poor |
| | prill | | | | | |
| | Pluronic | Methyl-oxirane polymer with oxirane | 30% | (9.8) | 1750 | Poor |
| | PE4300 | | | | | |
| | Pluronic L62 | Methyl-oxirane polymer with oxirane | 20% | 1-7 | 2500 | |
| | (PE6200) | | | | | |
| | Pluronic L64 | Methyl-oxirane polymer with oxirane | 40% | 13.4 | 2900 | Poor |
| | (PE6400) | | | | | |
| | Pluronic | Methyl-oxirane polymer with oxirane | 80% | >24 | 8000 | Poor |
| | PE6800 (F68) | | | | | |
| | Pluronic PE9400 | Methyl-oxirane polymer with oxirane | 40% | 17 | 4600 | Poor |
| | Pluronic | Methyl-oxirane polymer with oxirane | 50% | 12-18 | 6500 | Poor |
| | PE10500 (P105) | | | | | |
| | Tetronic 304 | Ethylenediamine, ethoxylated and | 40% | 12-17 | 1650 | Poor |
| | | propoxylated | | | | |
| | Tetronic 904 | Ethylenediamine, ethoxylated and | 40% | 12-18 | 6700 | Poor |
| | | propoxylated | | | | |
| Ashland | Natrosol 250GR | Hydroxyethylcellulose | | | | Poor |
| | Natrosol 250LR | Hydroxyethylcellulose | | | | Poor |

Upon closer evaluation of the ethoxylated compounds listed in Tables 2 and 3, is was surprisingly discovered that most of the good performers had an EO number or EO percent greater than or equal to 20 and an HLB value of greater than or equal to 12. This written description uses examples to disclose the invention, including the best mode, and also to enable any person skilled in the art to practice the invention, including making and using any devices or systems and performing any incorporated methods. These examples are merely illustrative and do not limit the invention in any manner. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A biocidal delivery composition for delivering an anti-microbial composition into biofouling or a bio-film of the type containing at least one micro-organism species and present in an industrial system, wherein
(a) said biocidal delivery composition comprises at least one stabilizer;
(b) said biocidal delivery composition comprises a vesicular structure; and
(c) said vesicular structure encapsulates said anti-microbial composition therein.

2. The biocidal delivery composition of claim 1, wherein said stabilizer comprises a polymer containing at least one ethylene oxide monomeric unit.

3. The biocidal delivery composition of claim 2, wherein said stabilizer comprises at least one ethoxylated compound having the formula: 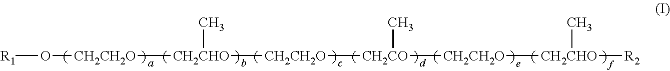
where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50; the sum of a, c and e is an integer from 5 to 200; the sum of b, d, and f is a number from 0 to 50.

4. The biocidal delivery composition of claim 3, wherein said ethoxylated compound comprises at least one member selected from the group consisting of alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, and poly(ethylene glycol-co-propylene glycol) monoalkyl ether.

5. The biocidal delivery composition of claim 2, wherein said stabilizer has a hydrophilic-lipophilic balance value ranging from about 8 to about 20.

6. The biocidal delivery composition of claim 2, wherein said stabilizer is incorporated in an amount ranging from about 0.1 wt % to about 10 wt % of the total biocide delivery composition.

7. The biocidal delivery composition of claim 6, wherein said stabilizer is incorporated in an amount ranging from about 0.5 wt % to about 5 wt % of the total biocide delivery composition.

8. The biocidal delivery composition of claim 1, wherein said vesicular structure comprises a liposome structure with at least one lipid.

9. The biocidal delivery composition of claim 8, wherein said lipid comprises at least one member selected from the group consisting of phospholipid, lecithin, phosphatidyl choline, glycolipid, triglyceride, sterol, fatty acid, and sphingolipid.

10. The biocidal delivery composition of claim 8, comprising from about 1.0 wt % to about 20.0 wt % of said lipid therein.

11. The biocidal delivery composition of claim 10, comprising from about 5.0 wt % to about 10.0 wt % of said lipid therein.

12. The biocidal delivery composition of claim 1, wherein said anti-microbial composition comprises at least one non-oxidizing biocide.

13. The biocidal delivery composition of claim 12, wherein said non-oxidizing biocide comprises at least one member selected from the group consisting of 5-chloro-2-methyl-4-isothiazolin-3-one, 2-methyl-4-isothiazolin-3-one, guanidine or biguanidine salts, quaternary ammonium salts, phosphonium salts, 2-bromo-2-nitropropane-1,3-diol (BNPD), n-alkyl-dimethylbenzylammonium chloride, dodecylguanidine hydrochloride, and glutaraldehyde.

14. The biocidal delivery composition of claim 12, comprising from about 0.1 wt % to about 90.0 wt % of said non-oxidizing biocide therein.

15. The biocidal delivery composition of claim 14, comprising from about 1.5 wt % to about 30.0 wt % of said non-oxidizing biocide therein.

16. The biocidal delivery composition of claim 1, further comprising a stabilizing buffer.

17. The biocidal delivery composition of claim 16, wherein said stabilizing buffer comprises at least one member selected from the group consisting of citrate salt, acetate salt, and chlorate salt.

18. The biocidal delivery composition of claim 16, comprising from about 0.02 wt % to about 20 wt % said stabilizing buffer therein.

19. A method for delivering a biocidal composition into an industrial system with biofouling or a bio-film comprising:
(d) forming liposomes with a vesicular structure which encapsulates at least one anti-microbial composition;
(e) combining said liposomes with at least one stabilizer; and
(f) introducing an effective amount of said biocidal composition to said industrial system.

20. The biocidal delivery composition of claim 19, wherein said stabilizer comprises a polymer containing at least one ethylene oxide monomeric unit.

21. The method of claim 19, wherein said liposome structures are introduced at from about 0.01 ppm to about 200 ppm by volume of said industrial system.

22. The method of claim 21, wherein said liposome structures are introduced at from about 0.05 ppm to about 50 ppm by volume of said industrial system.

23. The method of claim 22, wherein said liposome structures are introduced at from about 0.05 ppm to about 5 ppm by volume of said industrial system.

24. The method of claim 20, wherein said stabilizer comprises at least one ethoxylated compound having the formula: 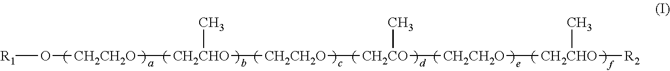
where R₁ and R₂ may be the same or different and are H, a branched alkyl phenol, a branched or linear fatty alcohol, a fatty acid alkanolamide, or a fatty acid; each of a, c and e is independently selected from 0 to 100; each of b, d and f is independently selected from 0 to 50; the sum of a, c and e is an integer from 5 to 200; the sum of b, d, and f is a number from 0 to 50.

25. The method of claim 24, wherein said ethoxylated compound comprises at least one member selected from the group consisting of alcohol ethoxylated, fatty alcohol ethoxylated, fatty alcohol ethoxylated-propoxylated, secondary alcohol ethoxylated, secondary fatty alcohol ethoxylated, secondary fatty alcohol ethoxylated-propoxylate, fatty alcohol polyglycol ether, modified fatty alcohol polyglycol ether, alcohols (C₆-C₁₂) ethoxylated, alcohols (C₁₀-C₁₈) ethoxylated, alcohols (C₆-C₁₂) ethoxylated-propoxylated, alcohols (C₁₀-C₁₈) ethoxylated-propoxylated, polyoxyethylene 2,6,8-trimethyl-4-nonyl ether, polyoxyethylene (20) sorbitan monolaurate, alkylphenol ethoxylated, polyethylene glycol monobutyl ether, polyethylene glycol trimethylphenylnonyl ether, polyethylene glycols, 2-ethyl hexanol ethoxylated, 2-ethyl hexanol ethoxylated-propoxylated, and poly(ethylene glycol-co-propylene glycol) monoalkyl ether.

26. The method of claim 20, wherein said wherein said stabilizer has a hydrophilic-lipophilic balance value ranging from about 8 to about 20.

27. The method of claim 20, wherein said stabilizer is incorporated in an amount ranging from about 0.1 wt % to about 10 wt % of the total biocide delivery composition.

28. The method of claim 27, wherein said stabilizer is incorporated in an amount ranging from about 0.5 wt % to about 5 wt % of the total biocide delivery composition.
